(19) United States
(12) Patent Application Publication
(10) Pub. No.: US 2015/0254509 A1
(43) Pub. Date: Sep. 10, 2015

(54) AUTHORIZATION METHOD AND SYSTEM BASED ON EYE MOVEMENT BEHAVIOR

(71) Applicant: National Taiwan Normal University, Taipei (TW)

(72) Inventor: Hong-Fa Ho, Taipei (TW)

(21) Appl. No.: 14/554,350

(22) Filed: Nov. 26, 2014

(30) Foreign Application Priority Data
Mar. 7, 2014 (TW) 103107822

(51) Int. Cl. G06K 9/00; G06K 9/46; G06K 9/62

(52) U.S. Cl. CPC G06K 9/00617; G06K 9/6215; G06K 9/46; G06K 9/00885; G06K 2009/4666

(57) ABSTRACT

An authorization method based on eye movement behavior is provided, which includes the steps of: displaying preset visual stimulus materials to a user; detecting eye movement states of the user during the user's viewing the preset visual stimulus materials so as to generate eye movement behavior; obtaining a set of authorization rules corresponding to the visual stimulus materials; and comparing the eye movement behavior with the set of authorization rules so as to pant authorization to the user if the eye movement behavior meets the set of authorization rules, thereby overcoming the conventional drawback of easy leakage of alphanumeric passwords and providing more variety to the authorization rules and the protection mechanism.

### BACKGROUND OF THE INVENTION

1. Field of the Invention

The present invention relates to authorization mechanisms, and, more particularly, to an authorization method and system based on eye movement behavior.

2. Description of Related Art

Currently, authorization information such as numbers, characters or symbols are generally inputted into devices through keyboards, mice or touch keyboards on touch screens. Then, the inputted information is compared with preset information, If it is determined that the inputted information is the same as the preset information, authorization is granted and corresponding processes are started or executed in the devices.

Authorization mechanisms are usually divided into non-physiological and physiological. For example, non-physiological authorization methods may use keyboards, spatial locations, eye movement information, gestures, postures or cards to make authorization determination, Physiological authorization methods may use fingerprints, palm prints, irises or voices to make authorization determination. However, both physiological and non-physiological methods have drawbacks. For example, during the process of inputting a password, the password is easily peeped by others, thus increasing the risk of leakage of the password. Also, by detecting fingerprints or temperature on keyboards, passwords can be easily stolen or duplicated. Although iris identification is not easily duplicated, it is difficult to determine whether the authorization behavior is forced or voluntary Further, palm prints or fingerprints are easily duplicated, and it is difficult to determine whether the authorization behavior is forced or voluntary. Therefore, to make authorization determination based on physiological or non-physiological characteristics has drawbacks.

Taiwan Patent Publication No. 201317822 discloses an eye tracking password input method and device. Such a method makes an authorization determination by detecting fixations of a user on numbers, characters or symbols in an input region. However, such a method does not take into account eye movement errors during the input process. US Patent Publication No. 2010/0017874 discloses a location aware authorization system and method. Such a method makes an authorization determination by comparing acquired spatial locations with particular rules, which however cannot determine whether the authorization behavior is forced or voluntary.

Therefore, there is a need to provide an authorization system and method so as to overcome the above-described drawbacks.

### SUMMARY OF THE INVENTION

In view of the above-described drawbacks, the present invention provides an authorization method based on a user's eye movement behavior so as to reduce the risk of leakage of passwords or forced authorization behavior, thereby improving the authorization security.

The authorization method according to the present invention comprises the steps of: displaying preset visual stimulus materials to a user; detecting eye movement state of the user when viewing the preset visual stimulus materials so as to generate eye movement behavior; obtaining a set of authorization rules corresponding to the visual stimulus materials; and comparing the eye movement behavior with the set of authorization rules so as to grant authorization to the user if the eye movement behavior meets the set of authorization rules.

In an embodiment, the eye movement behavior comprises duration of a first fixation (DFF) of the user on at least one of regions of interest (ROI) in the visual stimulus materials, latency of the first fixation (LFF), total contact time (TCT), number of fixations (NOF), saccade, regression or a combination thereof, and eye movement scan paths between the regions of interest in the visual stimulus materials.

In an embodiment, the set of authorization rules comprises a plurality of authorization paths and at least a piece of non-eye-movement information, and the step of comparing the eye movement behavior with the set of authorization rules comprises providing authorization contents according to the authorization paths in combination with the non-eye-movement information.

The present invention further provides an authorization system based on eye movement behavior, which comprises: a display module that displays preset visual stimulus materials to a user; an eye movement module that detects eye movement state of the user when viewing the preset visual stimulus materials so as to generate eye movement behavior; a determination module that obtains a set of authorization rules corresponding to the visual stimulus materials and compares the eye movement behavior with the set of authorization rules so as to generate authorization commands when the eye movement behavior meets the set of authorization rules; and an authorization module that provides authorization contents according to the authorization commands.

In an embodiment, the set of authorization rules comprises a plurality of authorization paths, and the determination module generates an error range for the authorization paths and determines that the eye movement behavior meets the set of authorization rules if the eye movement behavior falls within the error range.

Therefore, the present invention provides visual stimulus materials to a user and detects eye movement state of the user when viewing the preset visual stimulus materials so as to generate eye movement behavior. Then, the present invention obtains a set of authorization rules corresponding to the visual stimulus materials and compares the eye movement behavior with the set of authorization rules so as to want authorization to the user if the eye movement behavior meets the set of authorization rules. As such, the present invention overcomes the conventional drawback that alphanumeric passwords are easily peeped or stolen by others, and, more importantly, reduces the risk that a user is forced to input authorization information. Further, based on different eye movement behaviors, possibly in combination with other non-eye-movement information, the present invention can provide various authorization contents, thereby effectively improving the authorization safety and practicability.

### BRIEF DESCRIPTION OF DRAWINGS

FIG. 1 is a schematic block diagram showing an authorization system based on eye movement behavior according to the present invention;

FIG. 2 is a schematic flow diagram showing an authorization method based on eye movement behavior according to the present invention; and

FIG. 3 is a schematic diagram showing an embodiment of eye movement behavior.

### DETAILED DESCRIPTION OF PREFERRED EMBODIMENTS

The following illustrative embodiments are provided to illustrate the disclosure of the present invention, these and other advantages and effects can be apparent to those in the art after reading this specification.

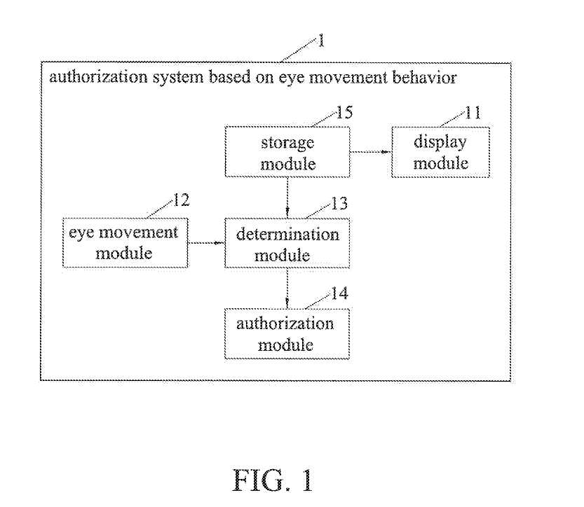

FIG. 1 is a schematic block diagram showing an authorization system based on eye movement behavior according to the present invention. Referring to FIG. 1, the authorization system 1 includes: a display module 11, an eye movement module 12, a determination module 13 and an authorization module 14.

The display module 11 is used to display preset visual stimulus materials to a user. The visual stimulus materials can be time-varying or time-invariant images, photos or movies. The visual stimulus materials can be stored in a storage module 15 of the authorization system 1 or a remote server (not shown) connected to the authorization system 1.

The eye movement module 12 is used to detect the eve movement state of the user during the user's viewing the visual stimulus materials so as to generate eye movement behavior. In particular, in order to prevent authorization information from being duplicated or stolen and reduce the risk of forced authorization behavior, the invention makes an authorization determination based on eye movement behavior.

The determination module 13 is used to obtain a set of authorization rules corresponding to the visual stimulus materials and compare the eye movement behavior with the set of authorization rules so as to generate authorization commands when the eye movement behavior meets the set of authorization rules. The set of authorization rules can include a plurality of authorization paths. That is, different authorization contents are provided according to different authorization paths.

The authorization module 14 is used to provide authorization contents according to the authorization commands. For example, a first authorization content corresponding to a first authorization command grants all access rights to the user. For example, there is no limit on withdrawal amount, A second authorization content corresponding to a second authorization command wants a portion of the access lights to the user. For example, there is a limit of ¥10,000 maximum withdrawal. In other words, different authorization paths corresponding to different eye movement behaviors result in different authorization commands, and accordingly different authorization contents are provided.

According to the authorization system 1 of the present invention, the display module 11 displays the preset visual stimulus materials to the user first, and then the eye movement module 12 detects the eye movement behavior. Subsequently, the determination module 13 determines whether the eye movement behavior meets the set of authorization rules corresponding to the visual stimulus materials so as to generate authorization commands, and finally the authorization module 14 provides the authorization contents according to the authorization commands.

Therefore, the present invention eliminates the need to use complicated characters, numbers or symbols as input passwords, and reduces the risk that passwords are stolen or duplicated. Further, if the user is forced to input authorization data, different authorization contents can be provided through different eye movement behaviors. For example, a general ATM authorization is to want the user to withdraw money. If the user is under duress, the user can input another set of eye movement behaviors. As such, even if money is withdrawn, the system can be automatically connected to the police for help.

Besides a plurality of authorization paths, the set of authorization rules can further include non-eye-movement information such as user account, password, physiological characteristics, date or time, In particular, different authorization contents can be provided according to different authorization paths in combination with the non-eye-movement information. Therefore, the determination module 13 first determines whether the eye movement behavior meets the set of authorization rules. If the eye movement behavior meets the set of authorization rules, the determination module 13 then makes an authorization determination according to the non-eye-movement information inputted by the user.

Furthermore, since the eye movement state cannot stably or accurately move along the paths, the determination module 13 generates an error range for the authorization paths, and determines that the eye movement behavior meets the set of authorization rules if the eye movement behavior falls within the error range, thereby preventing error determination caused by small path variation.

To increase the flexibility and variety of the eye movement behavior, the eye movement behavior can be preset by the user to be continuous or non-continuous. In particular, in the case that the eye movement behavior is non-continuous, if the user's eyes leave the visual stimulus materials for a while and then return, the leaving process will not be determined to be eye movement behavior. Otherwise, if the eye movement behavior is continuous, the user needs to keep his eyes on the visual stimulus materials.

Further, the eye movement behavior can take into account the state of the user on at least one of regions of interest in the visual stimulus materials and eye movement scan paths between the regions of interest in the visual stimulus materials. That is, the eye movement behavior includes duration of a first fixation of the user on at least one of the regions of interest in the visual stimulus materials, latency of the first fixation, total contact time, number of fixations, saccade, regression or a combination thereof. Further, the eye movement behavior can include eye movement scan paths between the regions of interest in the visual stimulus materials. For example, the user determines to look first at a region A and then at a region B and subsequently at a region C. The eye movement from the region A to the region B and then to the region C is referred to as an eye movement scan path. The eye movement scan paths in combination with the states of the regions of the interest can be used for authorization determination, which will be detailed later.

In order to facilitate the user to be familiar with his own eye movement, when detecting the eye movement state of the user when viewing the visual stimulus materials, the eye movement module 12 can present graphs or characters on the visual stimulus materials according to the eye movement state of the user. For example, a straight line represents a movement, a circle represents a fixation, and so on. The larger the radius of the circle is, the longer the duration of the fixation becomes. As such, the user can be familiar with his own eye movement when viewing the visual stimulus materials.

The authorization system 1 can be applied in many fields, such as mobile phone login and ATM withdrawal. The display module 11, the eye movement module 12, the determination module 13 and the authorization module 14 can be implemented in software, possibly in combination with hardware. For example, the display module 11 can be connected to a display screen for material displaying, and the eye movement module 12 can be connected to an image capture device for image capture. Since some necessary elements, such as processors and memories, are well known in the art, detailed description thereof is omitted herein.

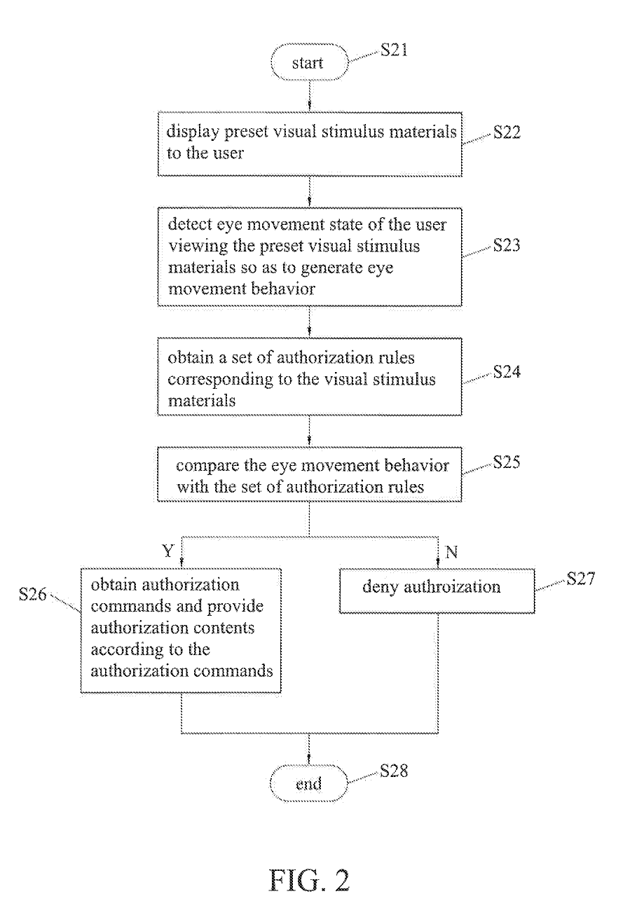

FIG. 2 is a schematic flow diagram showing an authorization method based on eye movement behavior according to the present invention.

Referring to FIG. 2, first, at step S21, when the user requests an authorization, an authorization determination starts. For example, to withdraw money from an ATM, the user chooses an operation to be performed.

Then, at step S22, preset visual stimulus materials are displayed to the user. The visual stimulus materials can be time-varying or time-invariant images, photos or movies, which can be set in advance according to the requirement of the user.

Further, the visual stimulus materials can be stored in a local device or a remote server according to the practical need. For example, an ATM password needs to be stored in a remote server and accessed when needed, thereby allowing the user to access different ATM machines. On the other hand, if the authorization mechanism is only applied in a single device, such as a mobile phone, the visual stimulus materials can be directly stored in the local device.

Subsequently, at step S23, the eye movement state of the user when the user views the visual stimulus materials is detected to generate eye movement behavior.

Then, at step S24, a set of authorization rules corresponding to the visual stimulus materials is obtained. As described above, the set of authorization rules can be set in advance by the user and stored in a local device or a remote server

The set of authorization rules can include a plurality of authorization paths. As such, different authorization contents can be provided according to different authorization paths. Preferably, the set of authorization rules can further include non-eye-movement information such as user account, password, physiological characteristics, date or time. Therefore, the invention provides more variety to the authorization mechanism by combining the authorization paths with the non-eye-movement information. For example, it can be required that no authorization is granted from 1:00 to 6:00 every day in another example, if the user inputs an A account and it is determined that the eye movement behavior meets the set of authorization rules, the maximum withdrawal amount will be ¥10,000 per transaction; otherwise, if the user inputs a B account and it is determined that the eye movement behavior meets the set of authorization rules, the maximum withdrawal amount will be ¥100,000 per transaction. Therefore, different authorization contents are provided according to different non-eye-movement information in combination with the authorization paths.

Subsequently at step S25, the eye movement behavior is compared with the set of authorization rules. If it is determined that the eve movement behavior meets the set of authorization rules, the process goes to step S26. Otherwise, the process goes to step S27.

At step S26, authorization commands are obtained and authorization contents are provided according to the authorization commands. Then, the process goes to step S28 to end the process.

At step S27, authorization is denied and the process goes to step S28 to end the process.

Further, since the eye movement state cannot stably or accurately move along the paths, an error range is generated for the authorization paths. If the eye movement behavior falls within the error range, it is determined that the eye movement behavior meets the set of authorization rules.

Furthermore, to increase the flexibility of the eye movement behavior, the eye movement behavior can be preset to be continuous or non-continuous according to the requirement. Non-continuous eye movement behavior allows the user's eyes to leave the visual stimulus materials for a while and then return. Also, the eye movement behavior takes into account the state of the user on regions of interest in the visual stimulus materials and eye movement scan paths between the regions of interest in the visual stimulus materials. That is, the eye movement behavior includes duration of fixations of the user on the regions of interest, latency of the fixations, number of fixations, total contact time, and so on. Further, the eye movement behavior includes eye movement scan paths between the regions of interest.

In addition, to facilitate the user to be familiar with his own eye movement, when detecting the eye movement state of the user when viewing the visual stimulus materials, graphs or characters corresponding to the eye movement state of the user can be presented on the visual stimulus materials. The graphs or characters can represent movement, fixation, etc.

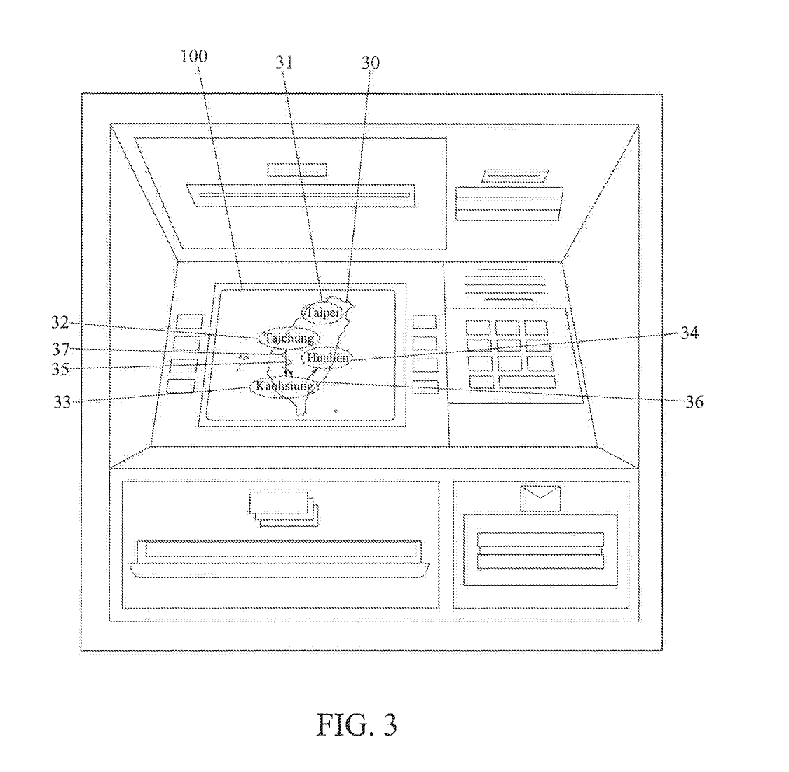

FIG. 3 shows an embodiment of the eye movement behavior according to the present invention. In the present embodiment, the authorization determination mechanism is applied on an ATM machine.

Referring to FIG. 3, to request an authorization determination, the user inserts his bank card into the ATM machine. Then, visual stimulus materials are displayed on a screen 100 of the ATM machine. In the present embodiment, the visual stimulus materials are shown as Taiwan map 30. A set of authorization rules can be preset corresponding to Taiwan map 30. For example, one of the authorization rules is set as follows: the user's eyes fix on Taipei 31 for 3 seconds; then, the user's eyes move to Taichung 32 and fix on Taichung 32 for 2 seconds; subsequently, the user's eyes move along path 35 to Kaohsiung 33 and fix on Kaohsiung 33 for 4 seconds; and finally, the user's eyes move along path 36 to Hualien 34 and fix on Hualien 34 for 5 seconds.

According to the above-described embodiment, the regions of interest are different locations on Taiwan map 30, i.e., Taipei 31, Taichung 32, Kaohsiung 33 and Hualien 34. Each of the regions of interest is delimited by a dashed line. As such, if the user looks at an area within the dashed line, it can be determined that the user's eyes fix on the region of interest. The duration of the fixation of the user on Taipei 31 is 3 seconds. The duration of the fixation of the user on Taichung 32 is 2 seconds. The duration of the fixation of the user on Kaohsiung 33 is 4 seconds. The duration of the fixation of the user on Hualien 34 is 5 seconds. Therefore, the total contact time of the user with the regions of interest is 3+2+4+5=14 seconds. Each of Taipei 31, Taichung 32, Kaohsiung 33 and Hualien 34 is visually fixed one time. The eye movement scan paths include path 35 and path 36. That is, the user's eyes must move along path 35 and path 36 for authorization. A saccade occurs when the user's eyes move from a first region of interest to a second region of interest without passing through a path, for example, when the user's eyes move directly from Taipei 31 to Taichung 32 without passing through any path. In the case the set of authorization rules require the user's eyes to move from a first region of interest to a second region of interest and then to a third region of interest, a regression occurs when the user's eyes move from the first region of interest to the second region of interest and then back to the first region of interest and thereafter move again to the second region of interest and then to the third region of interest. In this case, since the eye movement behavior still meets the required order of movement between the first, second and third regions of interest, it can be determined that the eye movement behavior meets the set of authorization rules. In the present embodiment, the set authorization rules require the user's eyes to move from Taipei 31 to Taichung 32 and then sequentially to Kaohsiung 33 and Hualien 34. In the determination process, when the user's eyes move from Taipei 31 to Kaohsiung 33 through Taichung 32, the user's eyes move back to Taichung 32 first and then to Kaohsiung 33 and finally reach Hualien 34. Since the eye movement behavior meets the required order of movement between the four regions of interest, it can be determined that the eye movement behavior meets the set of authorization rules.

In addition, the present embodiment takes into account an error range. If an error range is generated for an authorization path and it is determined that an eye scan path falls within the error range, it can be determined that the eye scan path meets the authorization path of the set of authorization rules. For example, referring to FIG. 3, even if the user's eyes do not fix on the central point of Taipei 31, as long as the user looks at an area within the dashed line of Taipei 31, it can be determined that the user's eyes fix on Taipei 31. In another embodiment, when moving along path 37, the user's eyes may slightly deviate from path 37. In this case, an error range can be generated for the path. If the eye movement behavior falls within the error range, it can be determined that the eye movement behavior meets the authorization path.

In addition, different combinations of authorization rules may provide different authorization contents. For example, a first authorization path requires the user's eyes to fix on Taipei 31 for 1 second and then move to Hualien 34 and fix on Hualien 34 for 2 seconds, and a second authorization path requires the user's eyes to fix on Taichung 32 for 2 seconds and then move along path 35 to Kaohsiung 33 and fix on Kaohsiung 33 for 4 seconds. If the eye movement behavior (including the order of movement and duration of each fixation) meets the first authorization path, a first authorization content is provided to grant all access rights to the user. For example, there is no limit on withdrawal amount.

Further, an alert mechanism can be provided according to different authorization contents. For example, although two different sets of authorization rules allow the user to withdraw money, one of the sets of authorization rules can secretly contact the police. As such, if the user is forced to perform authorization behavior, the police can be immediately informed.

Therefore, the present invention provides visual stimulus materials to a user and detects eye movement state of the user when viewing the preset visual stimulus materials so as to generate eye movement behavior. Then, the present invention obtains a set of authorization rules corresponding to the visual stimulus materials and compares the eye movement behavior with the set of authorization rules so as to determine whether to grant authorization to the user. As such, the present invention overcomes the conventional drawback that passwords are easily peeped or stolen by others. Further, based on different eye movement behaviors in combination with non-eye-movement information, regions of interest and eye movement scan paths, the present invention can provide, a variety of authorization contents, thereby reducing the risk that a user is forced to input authorization information. Therefore, the present invention provides an authorization mechanism having high safety.

The above-described descriptions of the detailed embodiments are only to illustrate the preferred implementation according to the present invention, and it is not to limit the scope of the present invention. Accordingly, all modifications and variations completed by those with ordinary skill in the art should fall within the scope of present invention defined by the appended claims.

What is claimed is:

1. An authorization method based on eye movement behavior, comprising the steps of:
displaying preset visual stimulus materials to a user;
detecting eye movement states of the user when viewing the preset visual stimulus materials, so as to generate eye movement behavior;
obtaining a set of authorization rules corresponding to the visual stimulus materials; and
comparing the eye movement behavior with the set of authorization rules so as to grant authorization to the user if the eye movement behavior meets the set of authorization rules.

2. The authorization method of claim 1, wherein the eye movement behavior comprises duration of a first fixation of the user on at least one of regions of interest in the visual stimulus materials, latency of the first fixation, total contact time, number of fixations, saccade, regression or a combination thereof, and eye movement scan paths between the regions of interest in the visual stimulus materials.

3. The authorization method of claim 1, wherein the eye movement behavior is continuous or non-continuous, and non-continuous eye movement behavior refers to a situation in which the user's eyes leave the visual stimulus materials for a while and then return.

4. The authorization method of claim 1, wherein the set of authorization rules comprises a plurality of authorization paths and at least a piece of non-eye-movement information, and the step of comparing the eye movement behavior with the set of authorization rules comprises providing authorization contents according to the authorization paths in combination with the non-eye-movement information.

5. The authorization method of claim 1, further comprising, when detecting eye movement state of the user viewing the preset visual stimulus materials, presenting graphs or characters on the visual stimulus materials according to the eye movement state of the user.

6. An authorization system based on eye movement behavior, comprising:
a display module that displays preset visual stimulus materials to a user;
an eye movement module that detects eye movement state of the user when viewing the preset visual stimulus materials, so as to generate eye movement behavior;
a determination module that obtains a set of authorization rules corresponding to the visual stimulus materials and compares the eye movement behavior with the set of authorization rules so as to generate authorization commands when the eye movement behavior meets the set of authorization rules; and
an authorization module that provides authorization contents according to the authorization commands.

7. The authorization system of claim 6, wherein the visual stimulus materials are time-varying or time-invariant images, photos or movies.

8. The authorization system of claim 6, wherein the set of authorization rules comprises a plurality of authorization paths and the determination module generates the authorization commands according to the authorization paths.

9. The authorization system of claim 8, wherein the determination module generates an error range for the authorization paths and determines that the eye movement behavior meets the set of authorization rules if the eye movement behavior falls within the error range,

10. The authorization system of claim 8, wherein the set of authorization rules further comprises non-eye-movement information of user account, password, physiological characteristics, date or time, and the determination module makes determination according to the authorization paths in combination with the non-eye-movement information.

11. The authorization system of claim 6, wherein the visual stimulus materials and the set of authorization rules are stored in a storage module of the authorization system or a remote server connected to the authorization system.
